(19) United States
(12) Patent Application Publication
(10) Pub. No.: US 2025/0232501 A1
(43) Pub. Date: Jul. 17, 2025

(54) IMAGE PROCESSING APPARATUS, METHOD AND NON-TRANSITORY COMPUTER-READABLE STORAGE MEDIUM

(71) Applicant: CANON KABUSHIKI KAISHA, Tokyo (JP)

(72) Inventor: AIKA FUNAKUBO, Kanagawa (JP)

(21) Appl. No.: 19/014,031

(22) Filed: Jan. 8, 2025

(30) Foreign Application Priority Data
Jan. 15, 2024 (JP) 2024-004118

(51) Int. Cl. G06T 11/60; G06T 7/11

(52) U.S. Cl. CPC G06T 11/60; G06T 7/11; G06T 2200/24; G06T 2207/10028; G06T 2207/20081; G06T 2207/20104; G06T 2207/30184

(57) ABSTRACT

An image processing apparatus that obtains defect information related to a defect detected from a captured image and instruction information for instructing content to include in a comment on the defect generates the comment and a level of the defect as an output result of a trained model that is based on the defect information and the instruction information, and displays text including the comment and the level of the defect.

### BACKGROUND

### Field

The present disclosure relates to an image processing technique.

### Description of the Related Art

Defects (cracking, water leakage, and the like) may occur on concrete surfaces of bridges and buildings due to various factors. Since a deficiency in a structure due to a defect must be discovered and repaired early, inspection workers have regularly carried out inspections by confirming concrete surfaces visually, and directly marking defect portions with chalk. After the inspection, an inspection report has been prepared in writing on a figure based on such chalk markings, and submitted to a government office. In recent years, to save on labor, systems in which inspection images obtained by capturing an image of a concrete surface with a camera are inputted into the system, and defects are automatically detected therefrom have come out. However, when such systems are used, it is necessary to make a final confirmation as to whether a plurality of defects detected automatically at the time of preparation of an inspection report are of a comparably similar detection accuracy to the case of visual inspection, and to submit a photograph or a figure in which a defect portion is clearly specified after making corrections as necessary. Therefore, to the inspection worker, the procedure for preparing the inspection report is still a lot of work. In “Automatic Generation of Descriptive Text on Damage Conditions based on Captured Images of Bridges by Deep Learning” by Tatsuro Yamane, Pang-jo Chun, Tatsuya Watanabe, Journal of the Society of Civil Engineers F3 (Civil Engineering Information Science), Vol. 77, No. 2, I_40-I_50, 2021, a technique for inputting an inspection image into an AI to output text on damage conditions within an inspection image for the purpose of automating inspection report preparation work has been studied.

In conventional inspection systems, all detected defects are outputted in a superimposed manner on one inspection image. However, detection results may include a mixture of accurate detection results which match an actual occurrence of a defect and inaccurate detection results which do not match an actual occurrence of a defect. It is necessary that only accurate detection results be put into the inspection report. Therefore, in order to prepare an inspection report, it is necessary for a user to find which of the detection results downloaded from the system are necessary, and to write out text for comments and individual determinations on each case of damage in consideration of the respective local government's determination criteria, as well as of materials and the surrounding environment. There is a problem that this work is still hard on the inspection worker.

### SUMMARY

The present disclosure provides a technique for generating comments and individual determination ranks that take into consideration defects that are appropriate for a report.

According to a first aspect of the present disclosure, an image processing apparatus comprises at least one memory storing a program and at least one processor that, when executing the program, causes the image processing apparatus to obtain defect information related to a defect detected from a captured image and instruction information for instructing content to include in a comment on the defect, to generate the comment and a level of the defect as an output result of a trained model that is based on the defect information and the instruction information, and to display text including the comment and the level of the defect.

According to a second aspect of the present disclosure, a method performed by an image processing apparatus comprises obtaining defect information related to a defect detected from a captured image and instruction information for instructing content to include in a comment on the defect, generating the comment and a level of the defect as an output result of a trained model that is based on the defect information and the instruction information, and displaying text including the comment and the level of the defect.

According to a third aspect of the present disclosure, a non-transitory computer-readable storage medium storing a computer program configured to cause a computer to execute a method, the method comprising obtaining defect information related to a defect detected from a captured image and instruction information for instructing content to include in a comment on the defect, generating the comment and a level of the defect as an output result of a trained model that is based on the defect information and the instruction information, and displaying text including the comment and level of the defect.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image processing apparatus 101.

FIG. 2 is a block diagram illustrating an example of a functional configuration of the image processing apparatus 101.

FIG. 3 is a view illustrating a configuration example of defect information.

FIG. 4 is a view illustrating an exemplary configuration of a GUI 401.

FIG. 5 is a view illustrating an exemplary configuration of a GUI 501.

FIG. 6 is a diagram illustrating a configuration example of a set to be stored in a storage unit 218.

FIG. 7 is a diagram illustrating an example of a range designation operation.

FIG. 8 is a diagram illustrating an example of a configuration of a data set to be stored in a storage unit 219.

FIG. 9 is a flowchart of processing performed by the image processing apparatus 101.

FIG. 10 is a view illustrating an exemplary configuration of a GUI 1001.

FIG. 11 is a flowchart of processing performed by the image processing apparatus 101.

FIG. 12A is a view illustrating an exemplary configuration of a GUI 1201.

FIG. 12B is a view illustrating an exemplary configuration of a GUI 1202.

FIG. 13A is a view illustrating an exemplary configuration of a GUI 1301.

FIG. 13B is a view illustrating an exemplary configuration of a GUI 1302.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but these embodiments are not seen to be limiting such that all described features are necessary, and multiple features can be combined as appropriate. In the attached drawings, the same reference numerals are given to the same or similar configurations, and redundant description thereof is omitted.

### First Embodiment

The present embodiment describes an example of an image processing apparatus that generates a comment and an individual determination rank, which is a level of a defect, as an output result of a trained model based on defect information related to a defect detected from a captured image obtained by capturing an image of a structure including the defect and instruction information for making an instruction about content to include in a comment on the defect. In the present embodiment, as an example, a case where an Artificial Intelligence (AI) model is used as the trained model will be described.

A “defect” is cracking, water leakage, or the like on concrete surfaces cause by factors such as damage or deterioration or the like to a structure such as an automobile road, a bridge, a tunnel, or a dam. “Cracking” is line shaped damage having a start point, an end point, a length, and a width and occurring on a wall surface of a structure or the like due to aging degradation, the shock of an earthquake, or the like. “Water leakage” indicates a condition in which due to the effects of rain or the like, water has entered the concrete through cracking or a gap in the concrete, and water is leaking out of the concrete.

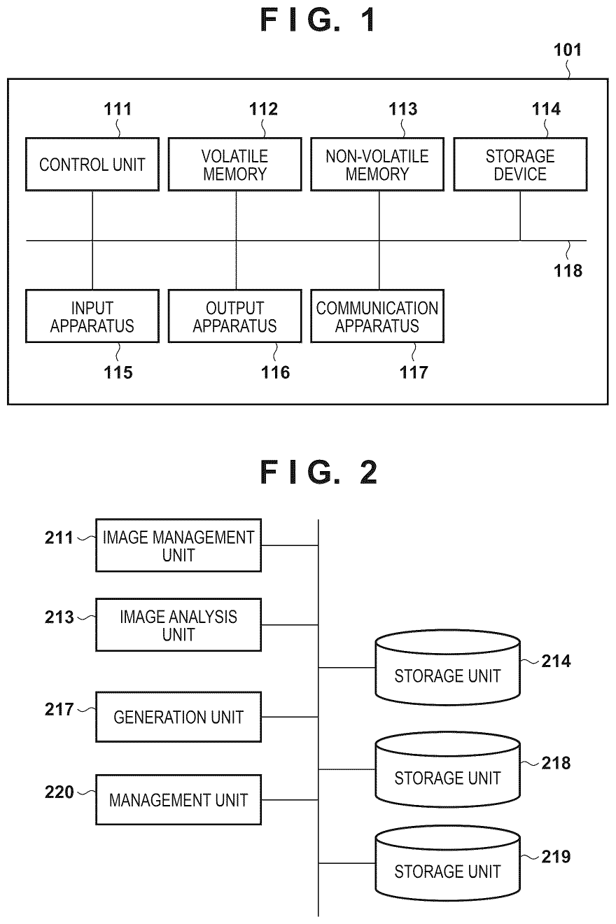

First, an example of a hardware configuration of an image processing apparatus 101 according to the present embodiment will be described with reference to a block diagram of FIG. 1. A computer apparatus such as a PC, a smart phone or a tablet terminal apparatus can be applied for the image processing apparatus 101 according to the present embodiment. Further, the image processing apparatus 101 may be implemented by one computer apparatus or may be implemented by a plurality of computer apparatuses. In the latter case, each of the computer apparatuses performs cooperative operations, so that processing described as processing performed by the image processing apparatus 101 is executed.

A control unit 111 is an arithmetic processor such as a CPU or an MPU, and executes various kinds of processing using computer programs and data stored in a volatile memory 112. Thus, the control unit 111 controls overall operation of the image processing apparatus 101 and executes or controls various processes described as processing performed by the image processing apparatus 101.

The volatile memory 112 is a memory for primary storage, and is, for example, a RAM. The volatile memory 112 has an area for storing computer programs and data loaded from a non-volatile memory 113, and an area for storing computer programs and data loaded from a storage device 114. Further, the volatile memory 112 has an area for storing computer programs and data received from the outside by a communication apparatus 117. Further, the volatile memory 112 has a work area used when the control unit 111 executes various processes. As described above, the volatile memory 112 can provide various areas as appropriate.

The non-volatile memory 113 is, for example, a ROM. The non-volatile memory 113 stores setting data of the image processing apparatus 101, computer programs and data related to activation of the image processing apparatus 101, computer programs and data related to basic operations of the image processing apparatus 101, and the like.

The storage device 114 is a large-capacity information storage apparatus such as a hard disk drive. The storage device 114 stores an OS, computer programs and data for causing the control unit 111 to execute or control various processes described as processes performed by the image processing apparatus 101, and the like.

Note that the storage device 114 may be a memory card as an internal device of the image processing apparatus 101 or a memory card externally attached to the image processing apparatus 101. The storage device 114 may be a disk drive that reads and writes computer programs and data from and to an optical disk such as a DVD or a Blue-ray Disc.

An input apparatus 115 is a user interface such as a keyboard, a mouse, or a touch panel screen, and a user can operate the input apparatus 115 to input various instructions and information into the image processing apparatus 101. In the following description, assume that a “user operation” is an operation performed by the user using the input apparatus 115.

An output apparatus 116 is a display apparatus including an LCD, an organic EL, or the like, and can display a result of processing by the control unit 111 using images, text, or the like. Note that the output apparatus 116 may be a projection apparatus such as a projector that projects images or text.

The communication apparatus 117 performs data communication with external units via a network such as the Internet or a LAN. A system bus 118 includes an address bus, a data bus, and a control bus. The control unit 111, the volatile memory 112, the non-volatile memory 113, the storage device 114, the input apparatus 115, the output apparatus 116, and the communication apparatus 117 are all connected to the system bus 118.

The processing performed in the image processing apparatus 101 according to the present embodiment is realized by, for example, a computer program and data of an application. It is assumed that the application includes software for using basic functions of an OS installed on the image processing apparatus 101. Note that the OS of the image processing apparatus 101 may include software for realizing various kinds of processing described as processing performed by the image processing apparatus 101. An example of a functional configuration of the image processing apparatus 101 is illustrated in a block diagram of FIG. 2. In FIG. 2, storage units 214, 218, and 219 can be implemented using a memory apparatus such as the volatile memory 112, the non-volatile memory 113, the storage device 114, or the like. In the present embodiment, a case in which an image management unit 211, an image analysis unit 213, a generation unit 217, and a management unit 220 are all implemented by software (computer programs) will be described. In the following, the image management unit 211, the image analysis unit 213, the generation unit 217, and the management unit 220 may be described as the performers of processing, but in practice, the functions of the functional units are realized by the control unit 111 executing a computer program corresponding to these functional units. Note that one or more functional units among the image management unit 211, the image analysis unit 213, the generation unit 217, and the management unit 220 may be implemented by hardware.

Next, a description will be given of processing performed by the image processing apparatus 101 for generating text describing a comment on a defect and an individual determination rank of the defect, based on a captured image obtained by capturing a structure including the defect and for causing the output apparatus 116 to display the generated text.

The image analysis unit 213 acquires a captured image that is a target (analysis target) for detecting a defect. The method of acquiring the captured image is not limited to a particular acquisition method. For example, the image analysis unit 213 may acquire a captured image transmitted from an external apparatus (a server apparatus, an image capturing apparatus, or the like) via the communication apparatus 117, or may acquire the captured image from the non-volatile memory 113 or the storage device 114.

Then, the image analysis unit 213, by inputting a captured image into an “AI model (machine learning/deep learning trained AI) that has been trained to detect a defect in an input image”, and performing arithmetic processing of the AI model, acquires defect information that is information on defects in the captured image. Then, the image analysis unit 213 stores, in a storage unit 214, a set of the captured image and defect information of each defect acquired from the captured image as an analysis result set.

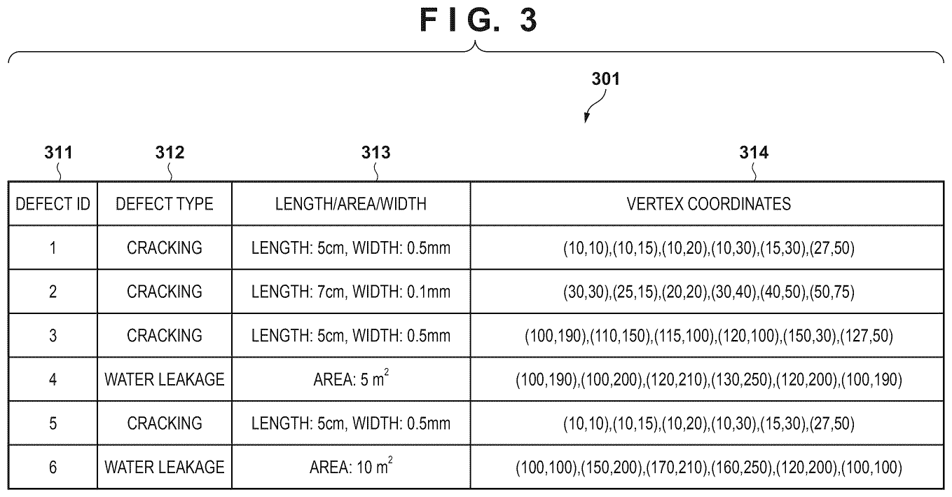

A configuration example of the defect information will be described with reference to FIG. 3. FIG. 3 shows defect information of each defect detected from a captured image; the defect information is vector data including a defect ID 311, a defect type 312, a length/area/width 313, and vertex coordinates 314, and is stored in the storage unit 214 in CSV, DXF, or another such format.

The defect ID 311 is unique identification information for each defect, and is represented by numerical values such as 1, 2, 3, . . . in FIG. 3. The defect type 312 is a defect type, and in FIG. 3, is one of “cracking” and “water leakage”. For example, the defect type 312 included in the defect information in which the defect ID 311 is “2” is “cracking”.

The length/area/width 313 is the size of the defect, and is the “length and width of the defect (damage width)” when the type of the defect is “cracking”, and is the “area of the defect” when the type of the defect is “water leakage”. For example, the length/area/width 313 included in the defect information in which the defect ID 311 is “2” is “length: 7 cm, width: 0.1 mm”. For example, the length/area/width 313 included in the defect information in which the defect ID 311 is “4” is “area: 5 m²”. With these sizes, for example, relative coordinates with respect to the position of a detection target object of the image in a planar rectangular coordinate system are expressed in millimeters. The vertex coordinates 314 are coordinates in the captured image of an end point (vertex) of each line segment in a case where a defect is represented by a plurality of line segments.

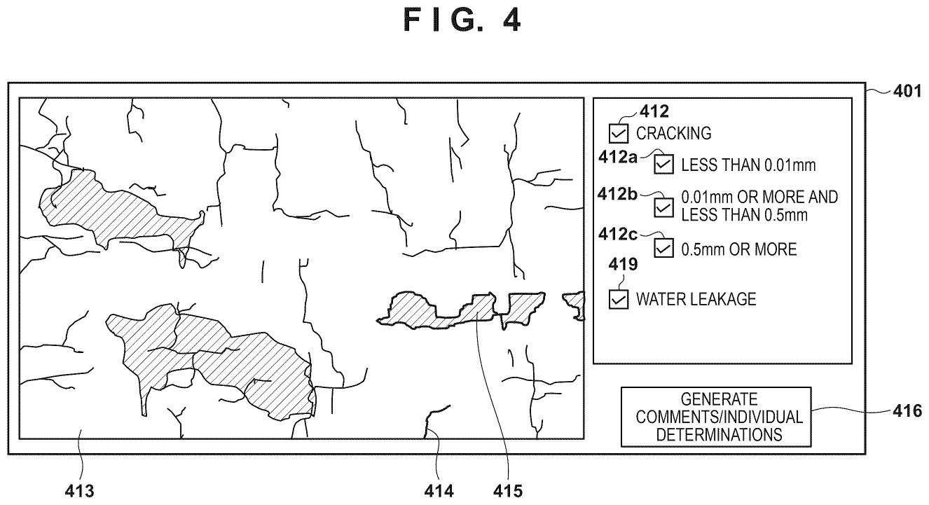

The image management unit 211 acquires an analysis result set stored in the storage unit 214, and displays a graphical user interface (GUI) 401 illustrated in FIG. 4 on the output apparatus 116. The image management unit 211 causes a captured image included in the acquired analysis result set to be displayed in a region 413.

Here, when the user checks a check box 412 using the input apparatus 115, the image management unit 211 selects, as first display candidates, the defect information whose defect type 312 is “cracking” among the defect information included in the analysis result set acquired from the storage unit 214.

When the user checks a check box 412a using the input apparatus 115, the image management unit 211 selects, as a display target, first display candidates whose width in the length/area/width 313 is “less than 0.01 mm” among the first display candidates.

Also, when the user checks a check box 412b using the input apparatus 115, the image management unit 211 selects, as a display target, first display candidates whose width in the length/area/width 313 is “0.01 mm or more and less than 0.5 mm” among the first display candidates.

Also, when the user checks a check box 412c using the input apparatus 115, the image management unit 211 selects, as a display target, first display candidates whose width in the length/area/width 313 is “0.5 mm or more” among the first display candidates.

Also, when the user checks a check box 419 using the input apparatus 115, the image management unit 211 selects, as a display target, the defect information whose defect type 312 is “water leakage” among the defect information included in the analysis result set acquired from the storage unit 214.

Then, the image management unit 211 generates objects that represent a defect corresponding to the defect information by a plurality of line segments, by sequentially referring to the coordinates from the beginning in the vertex coordinates 314 of the defect information selected as the display target and connecting the coordinates with line segments. Then, the image management unit 211 causes the generated objects to be superimposed on the captured image and displayed in the region 413.

An object 414 is an object generated by connecting coordinates by line segments with reference to coordinates in order from the beginning coordinates in the vertex coordinates 314 of the defect information in which the defect type 312 is “cracking”.

An object 415 is an object generated by connecting coordinates by line segments with reference to coordinates in order from the beginning coordinates in the vertex coordinates 314 of the defect information in which the defect type 312 is “water leakage”.

Note that the image management unit 211 determines in advance the superimposition order of the objects for each defect type so that the user can clearly visually recognize each defect. For example, for water leakage, a wide range represents the defect, whereas for cracking, the length and width of line segments represent the defect. Therefore, in the GUI 401 of FIG. 4, the object 415, which spans a wide range such as water leakage, and the object 414, such as cracking or the like, are displayed in a manner in which the object 415 and then the object 414 are superimposed on the captured image 413.

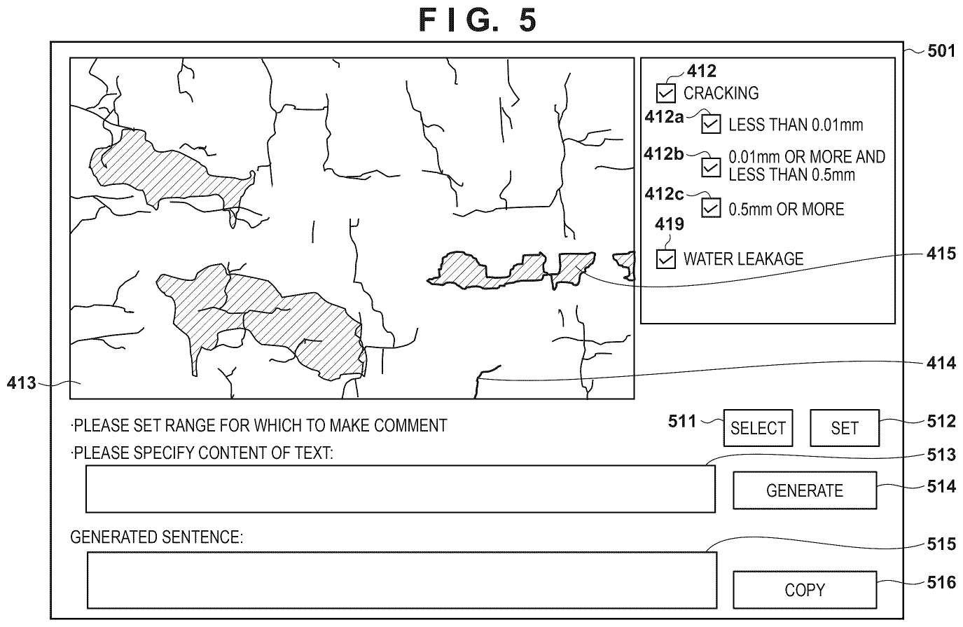

When the user uses the input apparatus 115 to make an instruction on the button 416, the image management unit 211 causes the output apparatus 116 to display a GUI 501 illustrated in FIG. 5. The GUI 501 is a GUI for generating, for a region designated in a captured image based on a user operation, a comment on a defect in the region and an individual determination rank, which is a level of the defect. In FIG. 5, the check boxes 412, 412a, 412b, 412c and 419 are all illustrated as checked.

Here, the comment is text data expressed to include the defect type 312 and the length/area/width 313 included in the defect information of the defect. The individual determination rank is distinguished based on the size of the defect of the structure and on overlap with a different type of defect, and is generated for each defect. The criteria for determining the individual determination rank is based on road inspection guidelines or the like of the country or respective local government.

When the user makes an instruction on a button 511 using the input apparatus 115, the image management unit 211 accepts an operation for designating a range in relation to the captured image displayed in the region 413. For example, as illustrated in FIG. 7, the user moves a mouse cursor 711 using a mouse as the input apparatus 115, and designates a range (defect range) in which to include defect objects that are targets for creating a comment and an individual determination rank, in the captured image displayed in the region 413. The method for designating a defect range (that is, a range of a portion in a captured image) is not limited to a particular designation method. For example, the user may designate a range in a graphic by clicking a mouse multiple times in the region 413 to set the clicked positions as vertices of the defect range. Also, for example, a shape graphic (a circle, a square, or the like) selected based on a user operation may be displayed in the region 413, and a range within the graphic may be designated as a defect range by performing enlargement/reduction/movement of the graphic based on a user operation. When a defect range is designated based on the user operation, the image management unit 211 displays a frame 712 of the designated defect range. In FIG. 7, a defect range including the object 414 and the object 415 is designated based on a user operation, and the frame 712 of the defect range is displayed. The defect range may be a range detected from the captured image by using a model that has been trained to detect defects in an image. Further, in subsequent processing, instead of a defect range, an image within a defect range or a processed image obtained by performing image processing (noise removal, edge enhancement, resizing, and the like) on that image may be used.

In addition, the user can input comment content instruction text data into a region 513 using the input apparatus 115. The comment content instruction text data is text data in which is recited content for instructing what content to include in a comment when an AI model is caused to output a comment. Such content includes, for example, “describe cracking in detail” and “describe overlapping of cracking and water leakage”, for example. Limitation is not made to this, and an instruction including other kinds of content may be inputted.

When the user makes an instruction on a button 512 using the input apparatus 115, the image management unit 211 specifies, as the target defect information, the defect information whose vertex coordinates 314 are included in the defect range among the defect information stored in the storage unit 214. In FIG. 7, defect information corresponding to the object 414 and defect information corresponding to the object 415 are identified as target defect information.

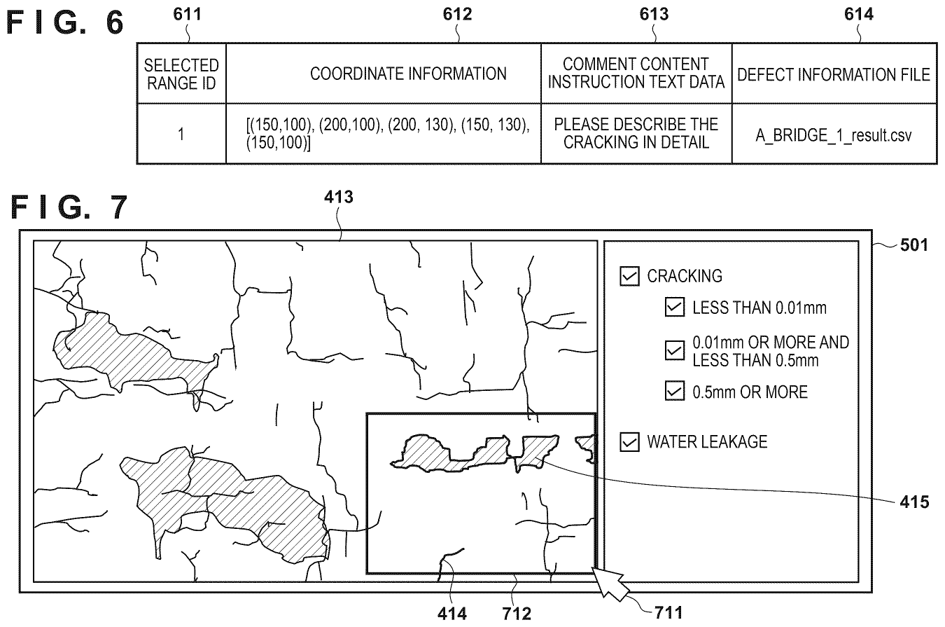

Then, the image management unit 211 stores, in the storage unit 218, a set of identification information unique to each defect range, coordinates of each vertex of the defect range, comment content instruction text data inputted into the region 513, and a file name of the target defect information. FIG. 6 shows an example of the configuration of the set stored in the storage unit 218.

A selection range ID 611 is unique identification information for each defect range. In FIG. 6, a case is assumed in which the selection range ID 611 is issued in order of 1, 2, 3, . . . , but limitation is not made thereto. Coordinate information 612 is coordinates of each vertex of the defect range. As another method for setting the coordinate information 612, a method based on a heat map calculated from a portion where defect information is concentrated, or an automated selection method using an AI model or the like specialized for range selection may be used. Comment content instruction text data 613 is comment content instruction text data that is inputted into the region 513. A defect information file 614 is a file name of target defect information.

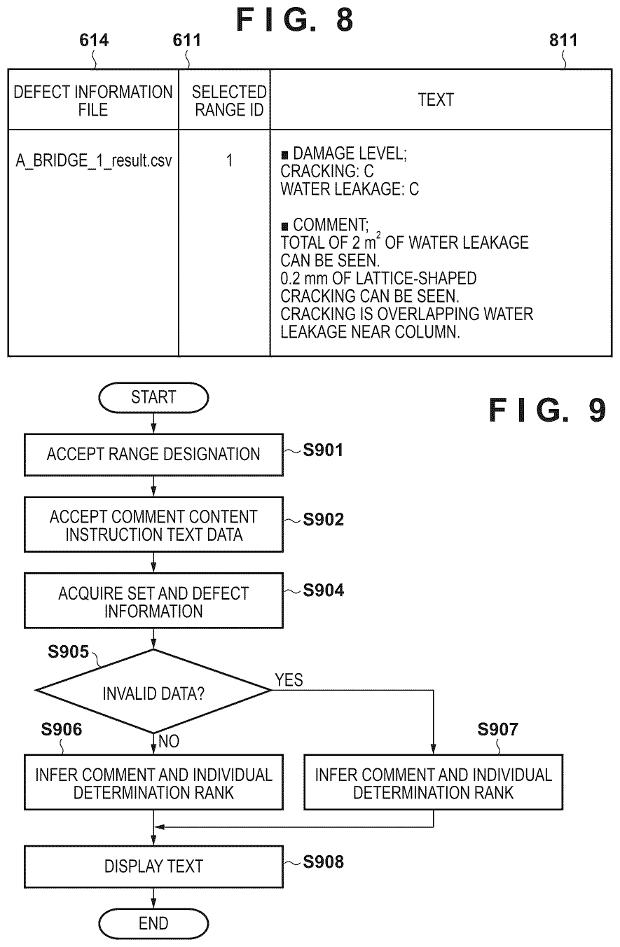

When the user makes an instruction on the button 514, the generation unit 217 infers the comment and the individual determination rank by using the set stored in the storage unit 218 and the AI model. The AI model used by the generation unit 217 is an AI model that has been trained in advance by machine learning or the like to output (infer) a corresponding comment and individual determination rank when defect information, a defect range, comment content instruction text data, and the like are inputted. Accordingly, the generation unit 217 inputs the defect information specified by the defect information file 614 in the set stored in the storage unit 218, the coordinate information 612 in the set stored in the storage unit 218, and the comment content instruction text data in the set stored in the storage unit 218 into the AI model, and performs an arithmetic process of the AI model to thereby infer the corresponding comment and the individual determination rank. Then, the generation unit 217 stores a data set including the result of the inference in the storage unit 219. FIG. 8 shows an example of the configuration of the data set stored in the storage unit 219.

The defect information file 614 is a file name of defect information specified by the defect information file 614 in the set stored in the storage unit 218. The selection range ID 611 is the selection range ID 611 in the set stored in the storage unit 218. Text 811 is text including a result (a comment and an individual determination rank) inferred by the AI model for the set stored in the storage unit 218.

Next, the image management unit 211 displays the text 811 in the data set stored in the storage unit 219 in a region 515 in the GUI 501 of FIG. 5. When the user makes an instruction on a button 516 using the input apparatus 115, the image management unit 211 copies the text 811 displayed in the region 515, for example, for use in an inspection report.

Processing performed by the image processing apparatus 101 after displaying the GUI 501 of FIG. 5 will be described based on the flowchart of FIG. 9. Note that the details of the processing in each step illustrated in FIG. 9 are as described above, and therefore will only be briefly described below.

In step S901, when the user makes an instruction on the button 511 using the input apparatus 115, the image management unit 211 accepts a range designation operation in relation to a captured image displayed in the region 413.

In step S902, the image management unit 211 accepts input of the comment content instruction text data into the region 513. Then, when the user makes an instruction on the button 512 by using the input apparatus 115, the image management unit 211 specifies the target defect information, and stores, in the storage unit 218, a set of: the identification information of the defect range received in step S901, the coordinates of each vertex of the defect range, the comment content instruction text data received in step S902, and the file name of the target defect information.

In step S904, when the user makes an instruction on the button 514, the generation unit 217 acquires the set stored in the storage unit 218 and acquires the defect information specified by the defect information file 614 in the set from the storage unit 214.

In step S905, the generation unit 217 determines whether or not the comment content instruction text data received in step S902 is invalid data such as NULL. When the user has not input the comment content instruction text data into the region 513 using the input apparatus 115, the comment content instruction text data is invalid data.

When the comment content instruction text data accepted in step S902 is determined to be invalid data such as NULL, the processing proceeds to step S907. Meanwhile, when the comment content instruction text data accepted in step S902 is determined to not be invalid data such as NULL, the processing proceeds to step S906.

In step S906, the generation unit 217 inputs the defect information specified by the defect information file 614 in the set stored in the storage unit 218, the coordinate information 612 in the set stored in the storage unit 218, and the comment content instruction text data in the set stored in the storage unit 218 into the AI model, and performs an arithmetic process of the AI model to thereby infer the corresponding comment and the individual determination rank. Then, the generation unit 217 stores a data set including the inference result in the storage unit 219 in association with the selection range ID in the set stored in the storage unit 218.

In step S907, the generation unit 217 inputs the defect information specified by the defect information file 614 in the set stored in the storage unit 218 and the coordinate information 612 in the set stored in the storage unit 218 into the AI model, and performs an arithmetic process of the AI model to thereby infer the corresponding comment and the individual determination rank. In this instance, the AI model performs the same processing as in step S906 using invalid data as the comment content instruction text data. Then, the generation unit 217 stores a data set including the inference result in the storage unit 219 in association with the selection range ID in the set stored in the storage unit 218.

Next, in step S908, the image management unit 211 displays the text 811 in the data set stored in the storage unit 219 in the region 515 in the GUI 501 of FIG. 5. Note that the display method of the text 811 is not limited to a specific display method.

### Second Embodiment

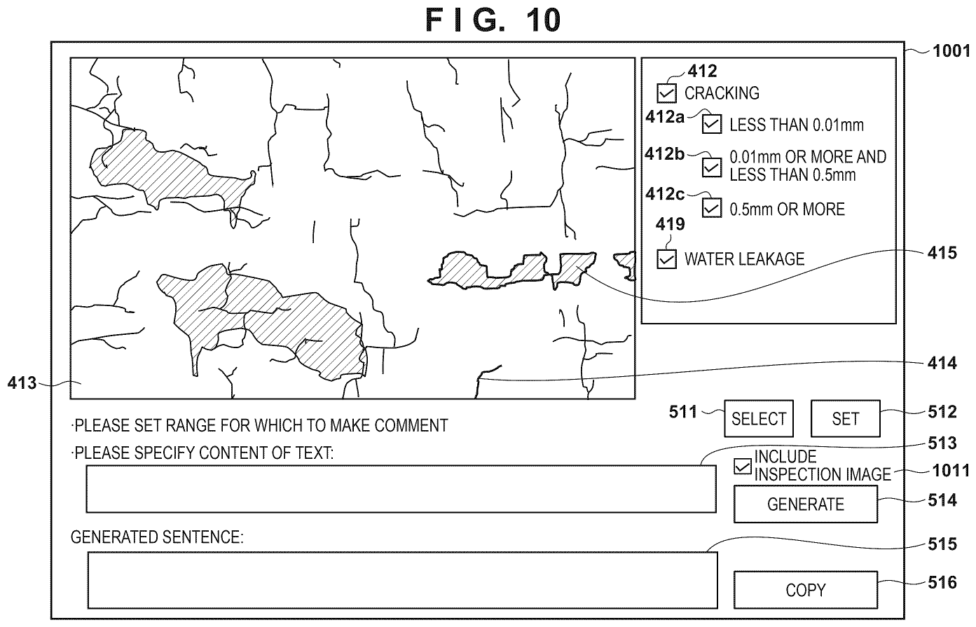

In the following embodiments including the present embodiment, differences from the first embodiment will be described; the embodiment is similar to the first embodiment unless otherwise specifically mentioned below. In the present embodiment, the comment and the individual determination rank are inferred in further consideration of the captured image. In this embodiment, a GUI 1001 of FIG. 10 is used instead of the GUI 501 of FIG. 5.

In the present embodiment, the AI model used by the generation unit 217 is an AI model that has been trained in advance by machine learning or the like to output (infer) a corresponding comment and individual determination rank when a captured image of a past defect is inputted in addition to defect information, a defect range, and comment content instruction text data. The comment also includes a sentence describing an image analysis result for a captured image of a defect and the analysis result.

When the user checks the check box 1011 using the input apparatus 115 in the GUI 1001, the generation unit 217 inputs the defect information specified by the defect information file 614 in the set stored in the storage unit 218, the coordinate information 612 in the set stored in the storage unit 218, the comment content instruction text data in the set stored in the storage unit 218, and the captured image displayed in the region 413 to the AI model, and performs arithmetic processing of the AI model, thereby inferring the corresponding comment and the individual determination rank. When the check box 1011 is not checked, the generation unit 217 operates in the same manner as in the first embodiment.

As described above, according to the present embodiment, it is easy to generate a comment and individual determination rank in consideration of the material, color, and the like of the structure included in the captured image, and it is possible to provide more suitable comments and individual determinations in the inspection report.

### Third Embodiment

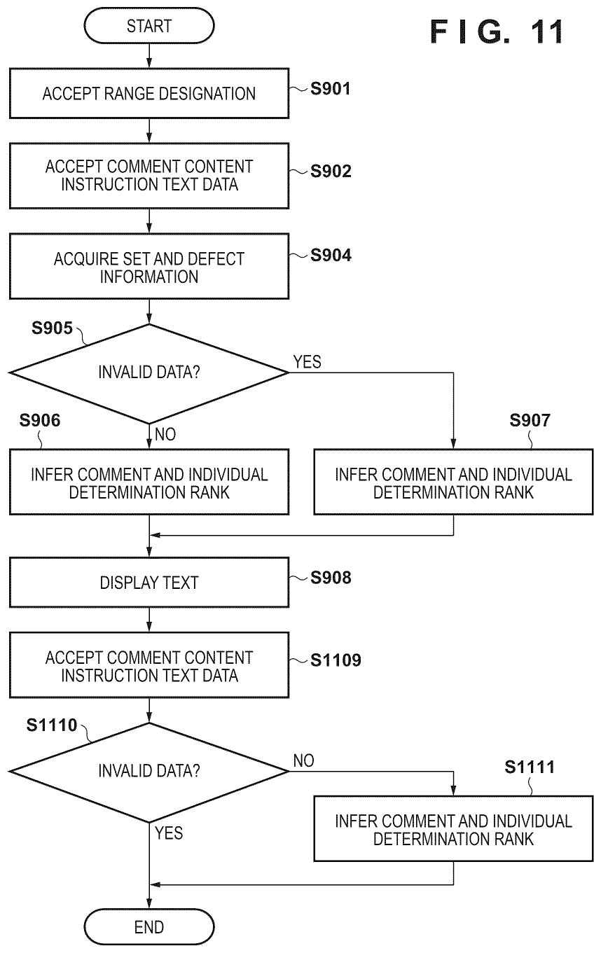

In the present embodiment, a comment and individual determination rank are regenerated when the accuracy of the comment and the individual determination rank inferred using the AI model is low or when the content is defective. Processing performed by the image processing apparatus 101 after displaying the GUI 501 of FIG. 5 will be described based on the flowchart of FIG. 11. In FIG. 11, processing steps similar to the processing steps illustrated in FIG. 9 are assigned the same step numbers, and description thereof is omitted.

When the user has confirmed the text 811 displayed on the output apparatus 116 and wants to correct the content/expression, the user re-inputs the comment content instruction text data into the region 513, and in step S1109, the image management unit 211 accepts the re-input.

Then, when the user makes an instruction on the button 512 by using the input apparatus 115, similarly to in the first embodiment, the image management unit 211 specifies the target defect information, and stores, in the storage unit 218, a set of: the identification information of the defect range received in step S901, the coordinates of each vertex of the defect range, the comment content instruction text data received in step S1109, and the file name of the target defect information.

In step S1110, when the user makes an instruction on a button 514, the generation unit 217 acquires the set stored in the storage unit 218 and acquires the defect information specified by the defect information file 614 in the set from the storage unit 214. Then, the generation unit 217 determines whether or not the comment content instruction text data accepted in step S1109 is invalid data such as NULL. When the comment content instruction text data accepted in step S1109 is determined to be invalid data such as NULL, the processing based on the flowchart of FIG. 11 ends. Meanwhile, when the comment content instruction text data accepted in step S1109 is determined not to be invalid data such as NULL, the processing proceeds to step S1111.

In step S1111, the generation unit 217 inputs the defect information specified by the defect information file 614 in the set stored in the storage unit 218, the coordinate information 612 in the set stored in the storage unit 218, and the comment content instruction text data in the set stored in the storage unit 218, as the text 811 of the previous time into a trained AI model, and performs an arithmetic process of the AI model to thereby infer the corresponding comment and the individual determination rank. Then, the generation unit 217 stores (overwrites) a data set including the inference result in the storage unit 219 in association with the selection range ID in the set stored in the storage unit 218.

After that, the image management unit 211, similarly to in the above-described step S908, displays the text 811 in the data set stored in the storage unit 219 in the region 515 in the GUI 501 of FIG. 5.

### Fourth Embodiment

In the present embodiment, a method will be described in which, when the image processing apparatus 101 generates a comment and an individual determination rank by using an AI model, a restriction on the defect types to be a target for generating a comment and individual determination rank and the level of detail of the content for each defect type are selected.

By restricting the defect types, the user can generate a comment and individual determination rank on only defects the user wishes to describe in the inspection report. Further, by selecting the level of detail for the content, it is possible to instruct the AI model as to specifically which defect types to write a comment on, and it is possible to generate a comment and individual determination rank for the content that the user requires. For example, if the content detail level for cracking is increased, comments on short-lengthed cracking will also be included. In addition, when the content detail level of water leakage is lowered, comments on slight water leakage, where the range is small for example will not be included.

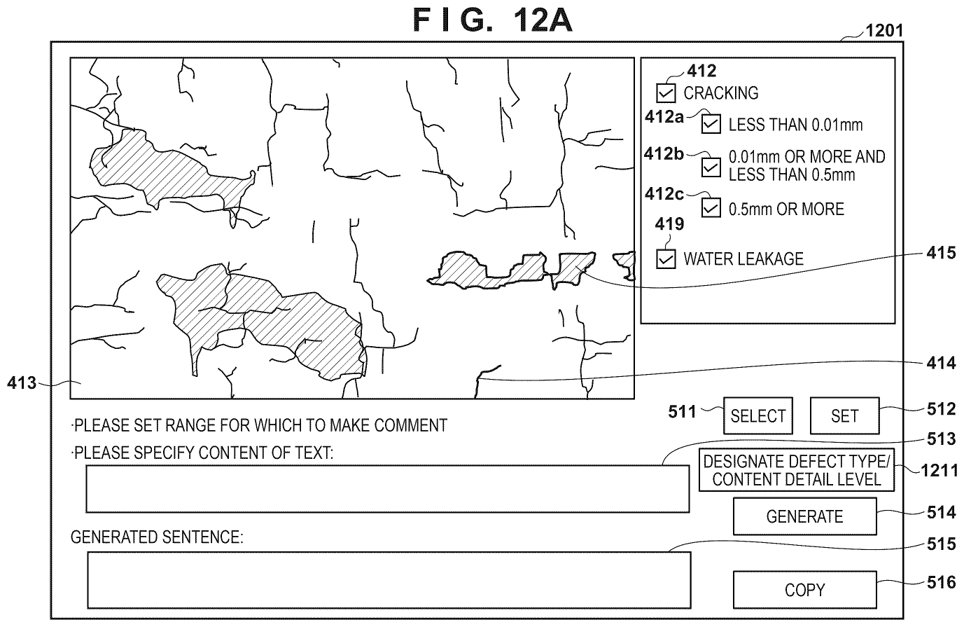

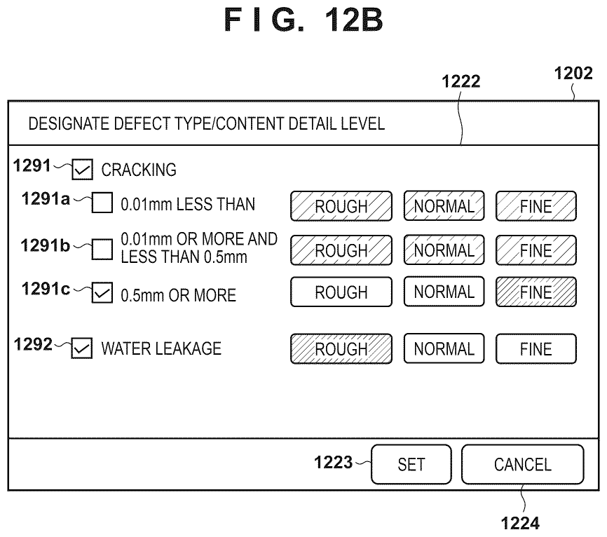

In this embodiment, a GUI 1201 of FIG. 12A is used instead of the GUI 501 of FIG. 5. When the user uses the input apparatus 115 to make an instruction on a button 1211, the image management unit 211 causes the output apparatus 116 to display a GUI 1202 illustrated in FIG. 12B.

When the user checks the check box 1291 using the input apparatus 115, the image management unit 211 includes “cracking” in the type of defect for which to generate a comment and individual determination rank.

When the user checks a check box 1291a using the input apparatus 115, the image management unit 211 sets that the comment and individual determination rank be generated for defects whose defect type is “cracking” and whose width is “less than 0.01 mm”.

When the user checks a check box 1291b using the input apparatus 115, the image management unit 211 sets that the comment and individual determination rank be generated for defects whose defect type is “cracking” and whose width is “0.01 mm or more and less than 0.5 mm”.

When the user checks a check box 1291c using the input apparatus 115, the image management unit 211 sets that the comment and individual determination rank be generated for defects whose defect type is “cracking” and whose width is “0.5 mm or more”.

When the user checks a check box 1292 using the input apparatus 115, the image management unit 211 includes “water leakage” in the type of defect for which to generate a comment and individual determination rank.

Also, a button group 1222 has a button for designating a content detail level indicating how finely the content of the comment is to be expressed and reflected in the comment/individual determination rank for each of the conditions “less than 0.01 mm”, “0.01 mm or more and less than 0.5 mm”, and “0.5 mm or more”. In FIGS. 12A and 12B, there are three levels for the content detail level, “rough”, “normal”, and “fine”; however, the content detail level may be set to be divided into more levels and may be designated by a numerical value. The user can use the input apparatus 115 to indicate any button in the button group 1222.

When the user makes an instruction on a button 1223 using the input apparatus 115, the image management unit 211 sets the types of defects for which to generate a comment and individual determination rank and the content detail levels respectively to the defect types and content detail levels set in the GUI 1202 of FIG. 12B. Meanwhile, when the user uses the input apparatus 115 to make an instruction on a button 1224, the image management unit 211 discards content set in the GUI 1202 of FIG. 12B.

When the user makes an instruction on the button 514, the generation unit 217 infers the comment and the individual determination rank by using the set stored in the storage unit 218 and the AI model. At this time, the generation unit 217, rather than using all of the defect information specified in the set, uses defect information having a defect type 312 that matches the “type of defect for which to generate a comment and individual determination rank”.

In other words, the generation unit 217 infers the corresponding comment and individual determination rank by inputting defect information having a defect type 312 matching the “defect type for which to generate a comment and individual determination rank” and the defect range and the comment content instruction text data in the set stored in the storage unit 218 into the AI model and performing the calculation process of AI model. At this time, the generation unit 217 outputs a comment corresponding to the content detail level that is set. For example, the generation unit 217 may use a trained AI model so that a comment corresponding to the set content detail level is outputted.

### Fifth Embodiment

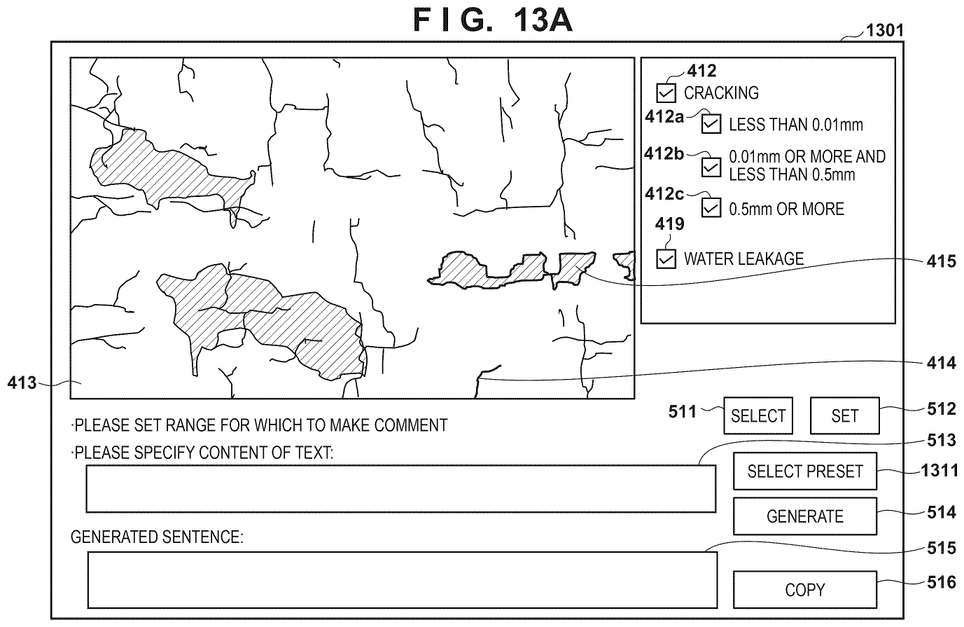

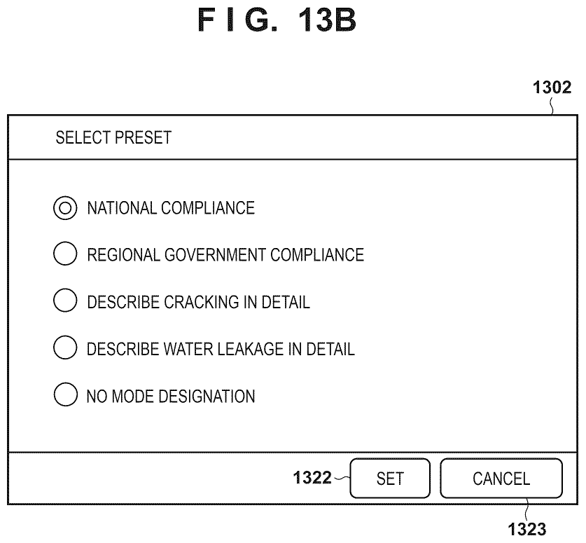

In the above embodiment, the user inputs the comment content instruction text data as a character string using the input apparatus 115, but in the present embodiment, the content for instructing what content to include in the comment is selected from a menu screen. In this embodiment, a GUI 1301 of FIG. 13A is used instead of the GUI 501 of FIG. 5.

When the user uses the input apparatus 115 to make an instruction on a button 1311, the image management unit 211 causes the output apparatus 116 to display a GUI 1302 illustrated in FIG. 13B. In the GUI 1302, a list of preset options as choices of content to include in the comment on the defect is displayed together with check boxes. All of the options in this list are options conforming to national and local government policies, or the like.

The user can check one of the check boxes displayed on the GUI 1302 using the input apparatus 115. When the user makes an instruction on a button 1322 using the input apparatus 115, the image management unit 211 sets the option corresponding to the checked check box as the comment content instruction text data, and displays the comment content instruction text data in the region 513. Meanwhile, when the user uses the input apparatus 115 to make an instruction on a button 1323, the image management unit 211 discards the content set in the GUI 1302.

As described above, according to the present embodiment, the user can set the comment content instruction text data by a simpler method, and can more efficiently generate a comment conforming to a policy of a country, a local government, or the like.

### Sixth Embodiment

In the above-described embodiments, information on the inspection target structure is not described as an input to the AI model, but information such as the type, shape, material, age, location, and the like of the structure may also be inputted to the AI model. Thereby, it is possible to generate high-quality comments/individual determination ranks in consideration of information such as the type and location of the structure. As described above, various types of information to be inputted to the AI model in order to acquire a comment and individual determination rank are conceivable, and therefore, the input to the AI model is merely an example. Incidentally, in the above-described embodiments and the present embodiment, the AI model is a model trained in advance to obtain an output in response to an input.

Further, in the above embodiments, a method of copying the generated comment/individual determination rank has been described. However, the functions that the image processing apparatus 101 is able to provide are not limited to this. For example, the image processing apparatus 101 may have a function for downloading “a partial image in a region set for a captured image displayed in the region 413 based on a user operation” and “text data of a generated comment/individual determination rank” to the terminal apparatus that has accessed the image processing apparatus 101.

In addition, the structures dealt with in the above-described embodiments are merely examples of a target for detecting a defect. Therefore, the definition of “defect” in the case where the target in which the defect is to be detected is other than a structure is not limited to the above definition.

In addition, the configuration and method for operating the GUIs used in the above-described embodiments are merely exemplary, and are not limited to a specific configuration or a specific operation method. For example, each GUI may be displayed as a separate window, or may be switched and displayed in one window using tabs or the like. Also, when a GUI is displayed on the touch panel screen, an operation on the GUI can be realized by an operation on the touch panel screen.

The numerical values, processing timings, processing order, subjects of processing, configuration/method of obtaining/transmission destination/transmission source/storage location of the data (information), and the like used in each of the above-described embodiments are given as examples for the purpose of concrete explanation, and there is no intention of limitation to such examples.

In addition, some or all of the respective above-described embodiments may be appropriately combined and used. Also, some or all of the respective above-described embodiments may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

This application claims the benefit of Japanese Patent Application No. 2024-004118, filed Jan. 15, 2024, which is hereby incorporated by reference herein in its entirety.

What is claimed is:

1. An image processing apparatus, comprising:
at least one memory storing a program; and
at least one processor that, when executing the program, causes the image processing apparatus to:
obtain defect information related to a defect detected from a captured image and instruction information for instructing content to include in a comment on the defect;
generate the comment and a level of the defect as an output result of a trained model that is based on the defect information and the instruction information; and
display text including the comment and the level of the defect.

2. The image processing apparatus according to claim 1, wherein the at least one processor is further causes the image processing apparatus to obtains defect information related to a defect included in a range of a portion of the captured image.

3. The image processing apparatus according to claim 2, wherein the at least one processor further causes the image processing apparatus to obtain, as the instruction information, text inputted based on a user operation as text for instructing content to include in the comment on the defect included in the range of the portion of the captured image.

4. The image processing apparatus according to claim 2, wherein the range of the portion is a range designated based on a user operation in relation to the captured image.

5. The image processing apparatus according to claim 2, wherein the range of the portion is a range detected from the captured image using a model trained to detect a defect in an image.

6. The image processing apparatus according to claim 2, wherein the at least one processor further causes the image processing apparatus to generate the comment and the level of defect as an output result of a trained model that is based on the defect information, the instruction information, the captured image, and information on the range of the portion.

7. The image processing apparatus according to claim 1, wherein the at least one processor further causes the image processing apparatus to obtain, as the instruction information, an option selected based on a user operation from a list of options preset as options for content to include in a comment on a defect.

8. The image processing apparatus according to claim 1, wherein the at least one processor further causes the image processing apparatus to generate the comment and the level of defect as an output result of a trained model that is based on the defect information, the instruction information, and the captured image.

9. The image processing apparatus according to claim 1, wherein the at least one processor further causes the image processing apparatus to obtain re-inputted instruction information.

10. The image processing apparatus according to claim 1, wherein the at least one processor further causes the image processing apparatus to generate the comment and the level of defect as an output result of a trained model that is based on defect information related to a defect of a type designated based on a user operation, instruction information for instructing content to include in a comment on the defect, and a level of detail on the content designated based on a user operation.

11. The image processing apparatus according to claim 1, wherein the at least one processor further causes the image processing apparatus to download, to a terminal apparatus, a partial image in the captured image and text including the comment and the level of defect.

12. A method performed by an image processing apparatus, the method comprising:
obtaining defect information related to a defect detected from a captured image and instruction information for instructing content to include in a comment on the defect;
generating the comment and a level of the defect as an output result of a trained model that is based on the defect information and the instruction information; and
displaying text including the comment and level of the defect.

13. A non-transitory computer-readable storage medium storing a computer program configured to cause a computer to execute a method, the method comprising:
obtaining defect information related to a defect detected from a captured image and instruction information for instructing content to include in a comment on the defect;
a generation unit configured to generate the comment and a level of the defect as an output result of a trained model that is based on the defect information and the instruction information; and
displaying text including the comment and level of the defect.
